(19) United States
(12) Patent Application Publication
(10) Pub. No.: US 2009/0277572 A1
(43) Pub. Date: Nov. 12, 2009

(54) FABRICATION AND ATTACHMENT OF MULTI-PART APPLIQUES

(76) Inventor: Yonghee Lee, Los Angeles, CA (US)

Correspondence Address: BELASCO, JACOBS & TOWNSLEY LLP;HOWARD HUGHES CENTER, 6701 CENTER DRIVE WEST, 14th Floor, LOS ANGELES, CA, 90045, US

(21) Appl. No.: 12/506,995

(22) Filed: Jul. 21, 2009

(51) Int. Cl. B44C 1/165

(52) U.S. Cl. 156/230

(57) ABSTRACT

A method of attaching a multi-part appliqué to a substrate fabric including: cutting a multi-part appliqué pattern into appliqué fabric; removing waste appliqué fabric, leaving a multi-part appliqué; applying a clear plastic sheet with a tacky glue surface to the appliqué, glue side down; turning the appliqué and plastic sheet over; applying thermosetting glue to the uncovered side of the appliqué; placing the appliqué glue side down, on a substrate fabric; hot pressing the appliqué to the substrate fabric; removing the plastic sheet from the appliqué; and allowing the assembly to cool to room temperature. Preferably the thermosetting glue is applied with a silk screen. Preferably the thermosetting glue is applied in beads of approximately 3 mm width and approximately 1 mm height. Preferably hot pressing is done at about 360°±10° F. with minimal pressure for about 6-10 seconds.

### BACKGROUND OF THE INVENTION

(1) Field of the Invention

The present invention relates to the field of fabrics and more particularly to the fabrication and attachment of fabric appliques to substrate fabrics.

(2) Description of the Related Art

It is well know how to fasten appliques made of cloth and other materials to other fabrics. Usually, the appliqué is cut out and fastened to the other fabric. The appliqué may be decorated with dye or paint before being applied and may be fastened by sewing or gluing. Appliqués can be cut via any method, for example by scissors, knives or metal dies. Another method is to apply an acid or caustic to the appliqué fabric with a silk screen. The chemical etches through the fabric leaving the desired appliqué shape. Appliqués are frequently used in fabrication of clothing.

All previously known methods of fabricating and attaching appliqués can only be economically used with appliqués having a single shape. It would be too labor intensive to use any of the previously known methods with appliqués which are comprised of multiple separate pieces.

United States Patent Application Publication No. 20090019644 describes a method of grafting decorated cotton fabrics to cotton cloths such as jeans with stencil. This method is comprised of: first step of printing a pattern on a cotton fabric by a stencil; second step of pasting a glue solution of Polyone S11111 SERIESONE CLEAR from Polyone Corporation on the rear side of the pattern on the cotton fabric; third step of overlapping the glue pasted cotton fabric over an article of clothing; fourth step of over-lapping the pattern containing stencil over the front side of the cotton fabric; fifth step of placing the stencil and the clothing under a heating press and pressing for 5 minutes at 160° C. (320° F.); sixth step of pasting a burn out gel on the stencil; and seventh step of removing the waste from the burn out from the clothing. This procedure is done with just a stencil and press and would be amenable to fabrication and attachment of multi-part appliqués to other fabrics.

Development of a process which can economically attach multi-part appliqués to substrate fabrics represents a great improvement in the field fabric manufacture and satisfies a long felt need of the garment manufacturer.

### SUMMARY OF THE INVENTION

The present invention is a method of attaching a multi-part appliqué to a substrate fabric comprising the steps of:

cutting a multi-part appliqué pattern into a sheet of appliqué fabric;

removing the waste appliqué fabric, leaving a multi-part appliqué;

applying a clear plastic sheet with tacky glue on one side to the multi-part appliqué, glue side down;

turning the multi-part appliqué with adhering clear plastic sheet over;

applying a thermosetting glue to the uncovered side of the multi-part appliqué

placing the appliqué glue side down, on a substrate fabric

hot pressing the multi-part appliqué to the substrate fabric;

removing the clear plastic sheet from the multi-part appliqué; and

allowing the assembly to cool to room temperature.

Preferably the thermosetting glue is applied with a silk screen. The thermosetting glue can be applied to all of the appliqué fabric or only portions of it. Preferably the thermosetting glue is applied in beads of approximately 3 mm width and approximately 1 mm height. The appliqué pattern can be cut by any convenient means, such as with a metal die. But it has been found that the optimum method to cut out the pattern is with a CO₂ laser.

Preferably hot pressing is done at about 360°±10° F. with minimal pressure for about 6-10 seconds.

The method as can additionally comprising the following optional steps:

hot pressing the multi-part appliqué to the substrate fabric so as to provide a layer of thermosetting glue on the top surface of the multi-part appliqué ;

placing a foil on top of the multi-part appliqué;

hot pressing the foil to the multi-part appliqué, whereby the thermosetting glue melts a second time and a further assembly of the foil to the multi-part appliqué and the substrate fabric is effected;

allowing the further assembly to cool to room temperature; and

removing portions of non-adhered foil.

This invention is different from the process of United States Patent Application Publication No. 20090019644. The main differences are that this invention does not utilize a stencil or burn out gel. An appreciation of the other aims and objectives of the present invention and an understanding of it may be achieved by referring to the accompanying drawings and description of a preferred embodiment.

### BRIEF DESCRIPTION OF THE DRAWINGS

FIG. 1 shows placement of a sheet of appliqué fabric on a work surface

FIG. 2 shows cutting out of the multi-part appliqué pattern with a CO₂ laser.

FIG. 3 shows removal of the waste appliqué fabric from the cut our multi-part appliqué.

FIG. 4 shows placing a sheet of clear plastic with tacky glue, tacky side down, onto the cut out multi-part appliqué.

FIG. 5 shows the appliqué turned over. In this view the clear plastic sheet is beneath the multi-part appliqué .

FIG. 6 shows application of the special glue to the multi-part appliqué with a silk screen.

FIG. 7 shows the multi-part appliqué with special glue applied.

FIG. 8 shows the multi-part appliqué and clear plastic sheet over the garment ready to be hot pressed into place. In this view the clear plastic sheet is on top of the multi-part appliqué and the special glue is on the bottom surface of the appliqué.

FIG. 9 shows the multi-part appliqué firmly bonded to the substrate fabric which in this case is a garment.

FIG. 10 shows a sheet of foil in place ready to be bonded to the multi-part appliqué in an optional additional step.

FIG. 11 shows the foil adhered to the multi-part appliqué which is in turn adhered to the substrate fabric which is in this case a garment.

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

This invention is a method for attaching appliques made of multiple separate pieces to other fabrics. This method comprises the following steps.

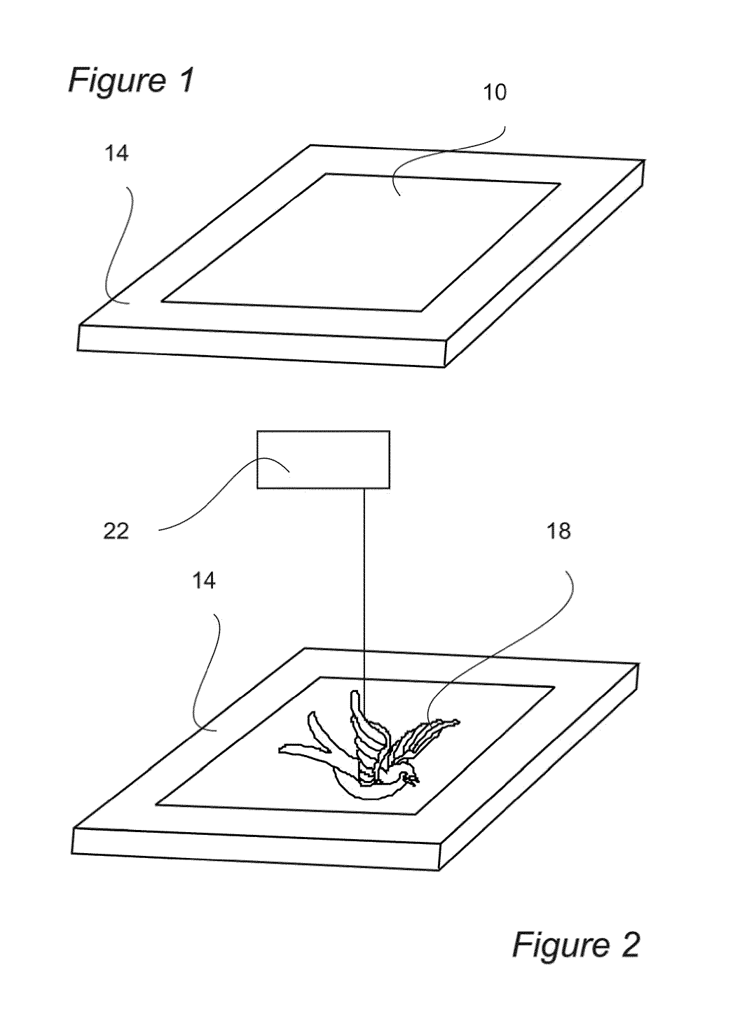

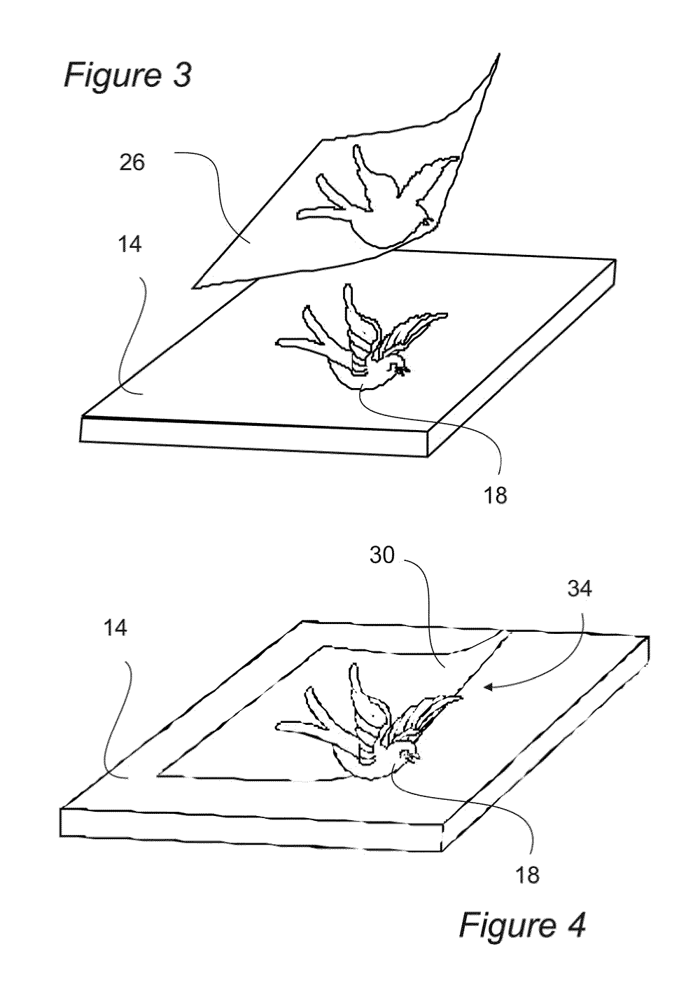

First, as shown in FIG. 1, appliqué fabric 10 is placed on a work bench 14 and, as shown in FIG. 2, the desired multi-part appliqué pattern 18 is cut out with a CO₂ laser 22. Other methods could be used, for example a metal die, but the CO₂ had been found to be optimal. As shown in FIG. 3, the waste fabric 26 is removed, leaving the multi-part appliqué 18.

As shown in FIG. 4, to stabilize the appliqué 18 during subsequent processing, a layer of clear plastic 30, with a clear, tacky glue 34 on one side is pressed onto the appliqué 18, glue side down. The glue 34 is formulated so that it is tacky at normal temperature but loses its tack when heated. Although, not illustrated, the other side of the appliqué 18 may be protected during subsequent handling by a sheet of slippery material such as silicone. Hot Fix Adhesive Tape (Product No. 2AP-8T1) from Daesang S.T. Co., Ltd. has been found to work well as the clear plastic with clear tacky glue and the release paper. This Tape comprises a layer of polyester film, a layer of acrylic adhesive and a layer of release paper.

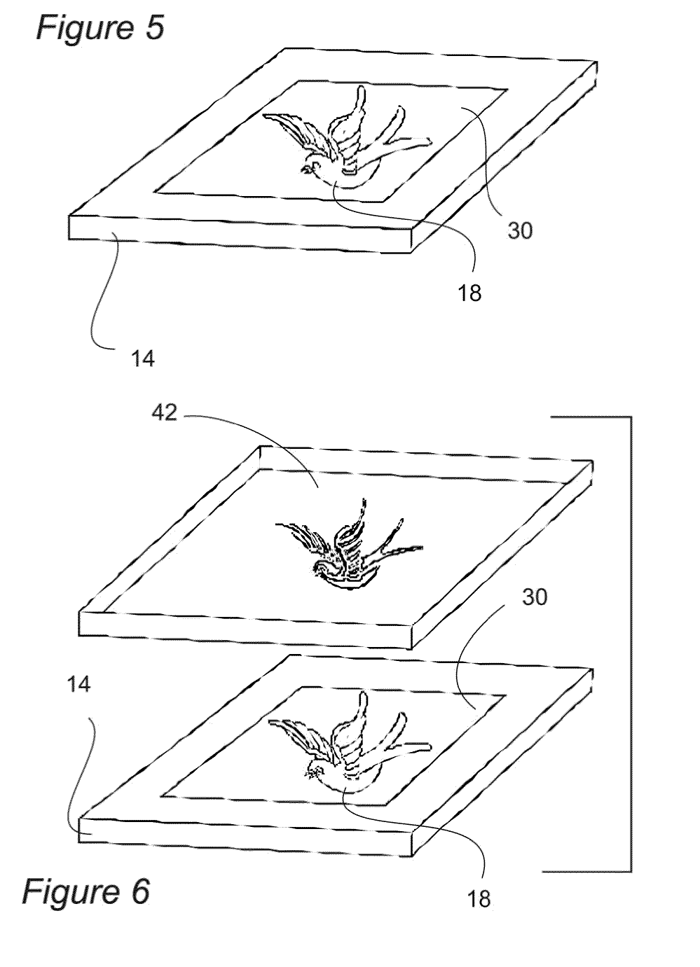

As illustrated in FIG. 5, the appliqué 18 and clear plastic sheet 30 are then turned over onto the same or another work bench 14. If present, the release paper is removed.

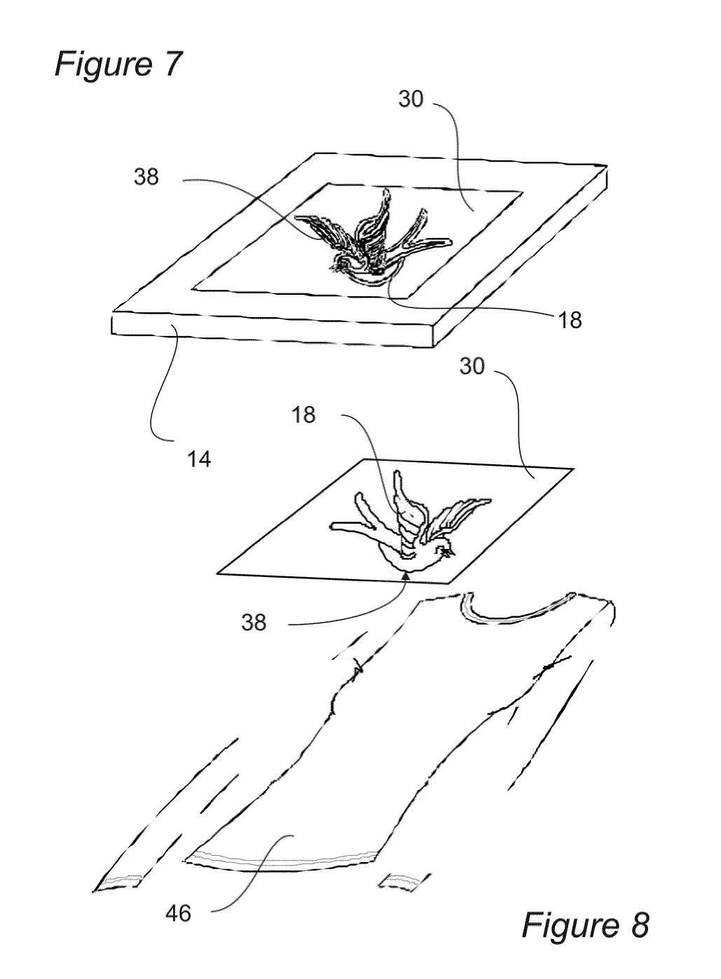

As illustrated in FIG. 7, a thermosetting glue 38 is then applied to the uncovered side of the appliqué 18. Application with a silk screen 42, as illustrated in FIG. 6, ensures that the glue 38 is only applied to the fabric and not to the cuts between pieces of the appliqué 18. The glue 38 may be applied to all of the appliqué 18 or only certain portions of it, as desired. Preferably, the glue 38 is applied in beads of approximately 3 mm width and approximately 1 mm height. Then after attachment to the substrate fabric 46 the effect will be like sewing. Further this method of attachment will allow the clothes to stretch and air to flow through well for comfortable wear. The glue 38 is comprised of 80%±10% of S11111 SERIESONE CLEAR (available from PolyOne Corporation of Avon Lake Ohio 44012), or equivalent and 20%±10% of MF66 Nylon Bonding Additive (available from QCM of Kent, Wash. 98032) or equivalent. Up to 5% of starch may be added to this mixture. The Nylon Bonding Additive increases hardness and the starch increases stickiness.

The release paper (not illustrated) may again be placed over the glue 38 until the appliqué 18 is attached to the substrate fabric 46.

As illustrated on FIG. 8, the appliqué 18 and clear plastic sheet 30 is placed, glue 38 side down, on the substrate fabric 46 and heat pressed. The heat is usually about 360° F. and minimal pressure is applied for about 6-10 seconds. The hot pressing technique is well known in the garment industry and heat transfer presses, such as the Model 204 manufactured by Insta of Cerritos, Calif. 90702-7900, are typically used. This causes the glue 38 to melt and squeeze into both fabrics 18, 46. It also causes the tacky glue 34 on the clear plastic sheet 30 to lose its tack.

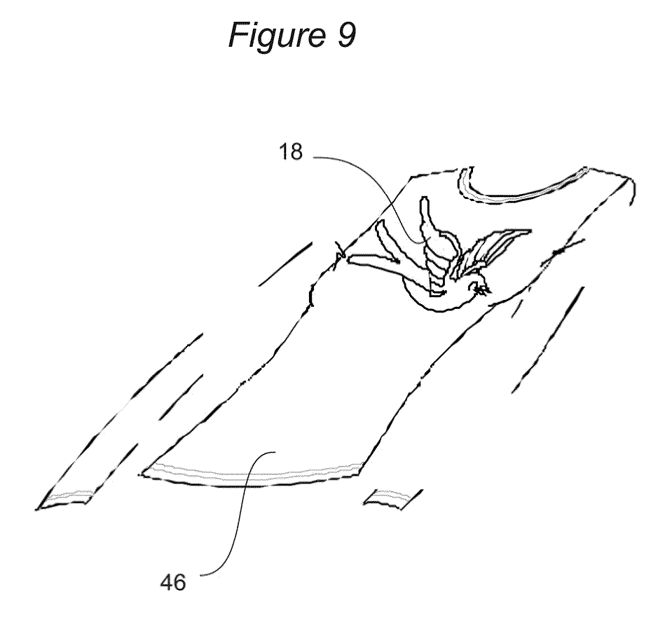

Finally, as illustrated on FIG. 9, the acrylic sheet 30 is removed from the appliqué 18 and the assembly 18, 46 is allowed to cool to room temperature. At this point the glue 38 sets and creates a permanent bond between the pieces of the appliqué 18 and the substrate fabric 46.

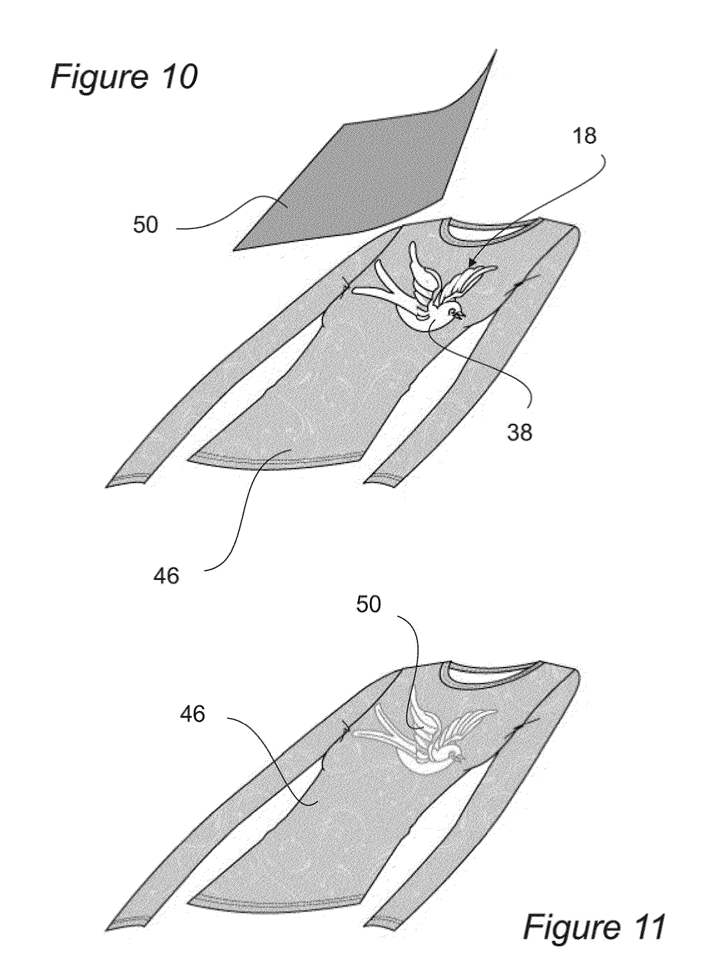

FIGS. 10 and 11 illustrate optional additional steps in the process. The additional steps allow overlay of the appliqué 18 with a foil 50. To prepare the appliqué 18 for attachment of the foil, when the appliqué 18 is heat bonded to the substrate fabric 46 as illustrated in FIG. 8, pressure is increased so that some of the thermosetting glue 38 squeezes through to the top surface of the appliqué 18.

Next, as illustrated in FIG. 10, a sheet of foil 50 is placed over the appliqué 18. Then heat and pressure are again applied. Heat is usually about 360° F. and minimal pressure is applied for about 6-10 seconds. This causes the thermosetting glue 38 to melt a second time.

The assembly 50, 46, 18 is allowed to cool to room temperature, at which point the glue 38 sets and creates a permanent bond between the pieces of the appliqué 18, the foil 50 and the substrate fabric 46. The foil 50 is so fragile that excess is easily removed resulting in the foil appliqué look illustrated in FIG. 11.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A method of attaching a multi-part appliqué to a substrate fabric comprising the steps of:
(a) obtaining appliqué fabric;
(b) obtaining clear plastic sheet with tacky glue on one side; said tacky glue being formulated to be tacky at normal temperature and to lose its tack when heated;
(c) cutting a multi-part appliqué pattern into said appliqué fabric;
(d) removing the waste appliqué fabric, leaving a multi-part appliqué;
(e) applying said clear plastic sheet to said multi-part appliqué, glue side down, whereby said multi-part appliqué becomes temporarily adhered to said clear plastic sheet by said tacky glue;
(f) turning said multi-part appliqué with adhered clear plastic sheet over;
(g) applying a thermosetting glue to the uncovered side of said multi-part appliqué
(h) placing said appliqué glue side down, on a substrate fabric
(i) hot pressing said multi-part appliqué to said substrate fabric, whereby an assembly of said multi-part appliqué to said substrate fabric is created;
(j) removing said clear plastic sheet from said multi-part appliqué; and
(k) allowing said assembly to cool to room temperature, whereby said thermosetting glue sets and creates a permanent bond between said multi-part appliqué and said substrate fabric.

2. A method as described in claim 1 further comprising the steps of:
(a) hot pressing said multi-part appliqué to said substrate fabric so as to provide a layer of thermosetting glue on the top surface of said multi-part appliqué;
(b) obtaining a sheet of foil;
(c) placing said foil on top of said multi-part appliqué;
(d) hot pressing said foil to said multi-part appliqué , whereby said thermosetting glue melts a second time and a further assembly of said foil to said multi-part appliqué and said substrate fabric is effected;
(e) allowing said further assembly to cool to room temperature, whereby said thermosetting glue sets and creates a permanent bond between said foil, said multi-part appliqué and said substrate fabric; and
(f) removing portions non-adhered foil.

3. A method as claimed in claim 1 in which said cutting step is performed with a CO₂ laser.

4. A method as claimed in claim 1 in which said thermosetting glue is applied with a silk screen.

5. A method as claimed in claim 1 in which said thermosetting glue is applied to all of said multi-part appliqué.

6. A method as claimed in claim 1 in which said thermosetting glue is applied to selected portions of said multi-part appliqué.

7. A method as claimed in claim 1 in which said thermosetting glue is applied in beads of approximately 3 mm width and approximately 1 mm height.

8. A method as claimed in claim 1 in which temperature for the hot pressing step is about 360°±10° F.

9. A method as claimed in claim 1 in which pressure for the hot pressing step is applied for about 6-10 seconds.
